(19) United States
(12) Patent Application Publication
(10) Pub. No.: US 2003/0096639 A1
(43) Pub. Date: May 22, 2003

(54) Distinctive recordable ringer

(76) Inventors: Dean K. Cluff, Portland, OR (US); Stephen K. Bigelow, Aloha, OR (US)

Correspondence Address: Timothy N. Trop, TROP, PRUNER & HU, P.C., STE 100, 8554 KATY FWY, Houston, TX, 77024-1805, US

(21) Appl. No.: 09/993,580

(22) Filed: Nov. 16, 2001

(51) Int. Cl. H04M 1/00

(52) U.S. Cl. 455/567; 455/556; 455/415

(57) ABSTRACT

A telephone user may custom record sounds to act as ringers when incoming calls are received. In some embodiments, the recorded sounds may be correlated to caller identification information so that different sounds are played back when different callers are calling.

### BACKGROUND

This invention relates generally to communication devices such as telephones and to ringers for those devices.

Existing telephones provide a variety of different telephone rings. Distinctive ringers (i.e., sounds generated to indicate an incoming call) may be utilized to distinguish one's cellular telephone from other proximate cellular telephones. Some manufacturers even enable users to download ringers from the Internet.

However, even with existing prerecorded or downloadable ringers, the large number of cellular telephone users must pick from a relatively limited set of ringer options. It would be more desirable to have a ringer option which is individually customizable.

Thus, there is a need for more options for ringers.

### BRIEF DESCRIPTION OF THE DRAWINGS

FIG. 1 is a block diagram of one embodiment of the present invention; and

FIG. 2 is a flow chart for software in accordance with one embodiment of the present invention.

### DETAILED DESCRIPTION

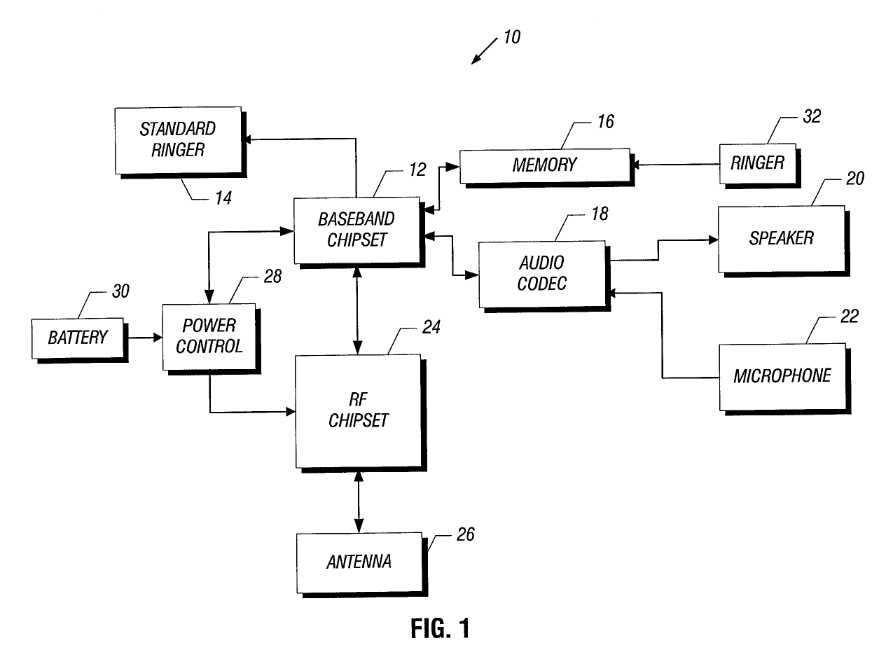

Referring to FIG. 1, a telephone 10 may be a cellular telephone in accordance with one embodiment of the present invention. However, the present invention is applicable to ringers for any of a variety of communication devices including telephones and pagers.

The telephone 10 includes a baseband chipset 12 coupled to a standard ringer device 14 in one embodiment. Also coupled to the chipset 12 is a memory 16. The memory 16 may store one or more ringer software programs 32. The baseband chipset 12 is also coupled to a speaker 20 and a microphone 22 through an audio coder/decoder (CODEC). The audio coder/decoder 18 provides analog to digital and digital to analog conversion as well as filtering and compression in some embodiments.

The baseband chipset 12 is also coupled to a radio frequency chipset 24 (in a cellular telephone embodiment) which is in turn coupled to an antenna 26. Power may be received in some embodiments from a battery 30 coupled via a power control 28 to the baseband chipset 12 and the radio frequency chipset 24.

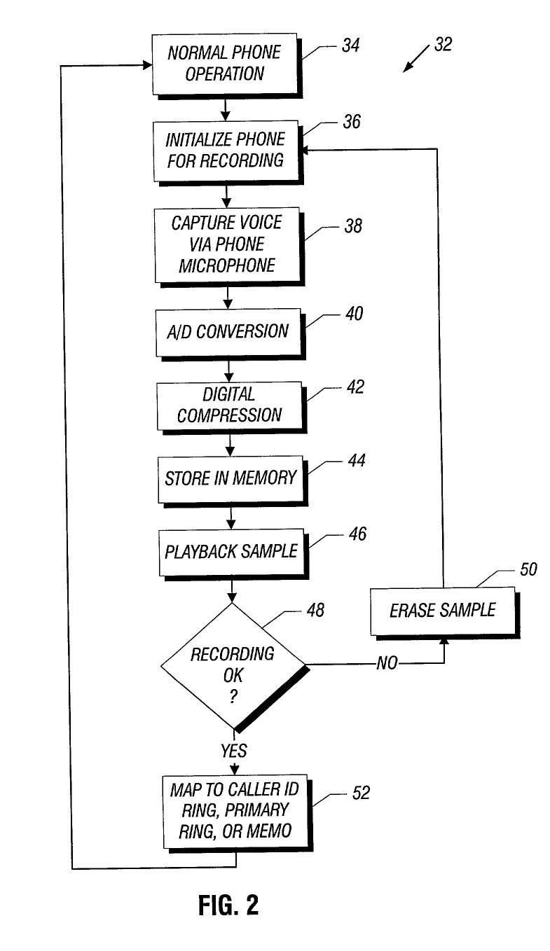

Turning next to FIG. 2, the ringer software program 32 includes an initial module for determining normal telephone operation as indicated in block 34. Thereafter, the telephone 10 may be initialized for recording as indicated in block 36. For example, in response to the user selection of a record button (not shown) on the housing of the telephone 10, the phone 10 may be switched from normal phone operation to the recording mode as indicated in block 36.

Whatever sound is present during a given recording interval is captured through the microphone 22 as indicated in block 38. The captured audio is then converted, as indicated in block 40, and compressed, as indicated in block 42, in some embodiments. The captured audio samples are then stored in the memory 16, as indicated in block 44. The samples may be automatically played back through the speaker 20 or ringer 14 as indicated in block 46.

The user may then be asked to indicate whether or not the recording is acceptable and the user's response may be determined in diamond 48. If the recording is not acceptable, the sample may be erased as indicated in block 50 and the flow repeated. If the sample is acceptable, the audio file may be mapped to the caller identification ring, primary ring, or a memo function as indicated in block 52. For example a graphical user interface may appear and the user may be asked to indicate a caller to be linked to the recorded audio file.

The audio file may be mapped to a particular caller identification of a caller identification (CID) system. When a call is received that corresponds to a particular caller identification, the distinctive, pre-recorded phone ringer is played automatically. For example, when a call comes from a given person, that person's caller identification may be recognized. A particular recorded audio file may be mapped to that caller's identifier. When that caller calls, the stored audio file may be played back automatically. That audio file may indicate who the caller is in one embodiment. For example, the audio file may advise that “Mr. Watson is calling.”

By associating audio files with different caller identifications, the ringer may be customized to the incoming call. By recording the user's voice identifying the incoming call, the telephone 10 user has an easy way to know who is calling at any time.

In embodiments in which caller identification is not utilized, the user may record his voice indicating that his phone is ringing. For example, the audio file may advise that “Mr. Smith your phone is ringing”.

Since any sound may be recorded, the user may simply record the sound which the user wants to have played when an incoming call is received. This allows effectively infinite customization of ringers that are easily distinguished by the user.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A communications device comprising:
a processor; and
a storage coupled to said processor, said storage storing instructions that enable the processor to record ambient sounds and to play back those ambient sounds when a incoming call is being received.

2. The device of claim 1 wherein said device is a cellular telephone.

3. The device of claim 1 including a speaker and a microphone coupled to said processor.

4. The device of claim 1 including caller identification to identify incoming callers.

5. The device of claim 4 wherein said storage stores instructions that enable the processor to match a caller identification to a recorded sound and to automatically play back the recorded sound when a given caller calls.

6. The device of claim 1 wherein said storage stores instructions to automatically playback a stored sound enabling the user to indicate whether or not the storage stored sound is acceptable.

7. A method comprising:
enabling a user to record a sound to be played back when a call is received; and
automatically playing back the sound when a call is received.

8. The method of claim 7 including mapping a caller identification to a recorded sound and automatically playing back the recorded sound when a call from a particular caller is received.

9. The method of claim 7 including automatically playing back a sound after a sound is recorded and enabling the user to indicate whether or not the sound is acceptable.

10. The method of claim 7 including enabling the user to record a user supplied sound.

11. The method of claim 10 including enabling a user to record the verbalization of the user's name.

12. The method of claim 7 including enabling the user to record a unique distinctive sound to be played back when a call is received.

13. An article comprising a medium storing instructions that enable a processor-based system to:
record ambient sounds; and
determine when an incoming call is being received and automatically play back said ambient sounds when an incoming call is being received.

14. The article of claim 13 further storing instructions that enable a processor-based system to associate a recorded sound with a caller identification and when a caller identification is received automatically play back the sound.

15. The article of claim 13 further storing instructions that enable the processor-based system to record a sound, automatically play back the sound, and determine whether the user approves the sound.

16. A cellular telephone comprising:
a baseband chipset;
a radio frequency chipset coupled to said baseband chipset; and
a memory storing instructions that enable the baseband chipset to record ambient sounds and to play back those ambient sounds when an incoming call is being received through said radio frequency chipset.

17. The telephone of claim 16 including a speaker and a microphone coupled to said baseband chipset.

18. The telephone of claim 16 including caller identification to identify incoming callers.

19. The telephone of claim 18 wherein said storage stores instructions that enable the baseband chipset to match a caller identification to a recorded sound and to automatically play back the recorded sound when a given caller calls.
